(19) United States
(12) Patent Application Publication
(10) Pub. No.: US 2013/0030932 A1
(43) Pub. Date: Jan. 31, 2013

(54) CASH REGISTER AND CASH PROCESSING APPARATUS

(71) Applicant: Shinichi Tokunaga, Shizuoka-ken (JP)

(72) Inventor: Shinichi Tokunaga, Shizuoka-ken (JP)

(73) Assignee: TOSHIBA TEC KABUSHIKI KAISHA, Tokyo (JP)

(21) Appl. No.: 13/551,797

(22) Filed: Jul. 18, 2012

(30) Foreign Application Priority Data
Jul. 29, 2011 (JP) 2011-167248
Mar. 29, 2012 (JP) 2012-076659

(51) Int. Cl. G06Q 20/20

(52) U.S. Cl. 705/16

(57) ABSTRACT

According to one embodiment, a cash register, that includes an input unit and is connected with a cash processing apparatus having a power control unit for turning on or off the power supply of each unit, comprises a power-on unit which turns on the power supply of the cash processing apparatus using the power control unit after the category of a commodity is input through the input unit.

### CROSS-REFERENCE TO RELATED APPLICATION

The present application contains subject matter related to that disclosed in Japanese Priority Patent Application JP 2011-167248 filed in the Japan Patent Office on Jul. 29, 2011 and Japanese Priority Patent Application JP 2012-076659 filed in the Japan Patent Office on Mar. 29, 2012 the entire contents of which are hereby incorporated by reference.

### FIELD

Embodiments described herein relate to a cash register and a cash processing apparatus.

### BACKGROUND

A cash processing system is known which comprises a cash register, an external unit connected in communication with the cash register and a cash processing apparatus for disbursing cash as change.

In addition, an apparatus is also known which supplies, in a coin processing unit installed inside a vending machine to store input coins as change coins, power to a coin detection circuit when the coin detection circuit detects the input of coins.

### BRIEF DESCRIPTION OF THE DRAWINGS

FIG. 1 is a diagram showing the whole structure of a register system according to one embodiment;

FIG. 2 is a diagram showing a structural example of a POS register according to the first embodiment;

FIG. 3 is a diagram showing a structural example of a cash processing apparatus according to the first embodiment;

FIG. 4 is a diagram showing a structural example of a host according to the first embodiment;

FIG. 5 is a diagram illustrating the actions carried out in the first embodiment;

FIG. 6 is a diagram showing a structural example of a cash processing apparatus according to the second embodiment;

FIG. 7 is a diagram illustrating the actions carried out in the second embodiment.

### DETAILED DESCRIPTION

According to one embodiment, a cash register, that includes an input unit and is connected with a cash processing apparatus having a power control unit for turning on or off the power supply of each unit, comprises a power-on unit which turns on the power supply of the cash processing apparatus using the power control unit after the category of a commodity is input through the input unit.

Embodiments of the present invention are described in detail below with reference to accompanying drawings.

### The First Embodiment

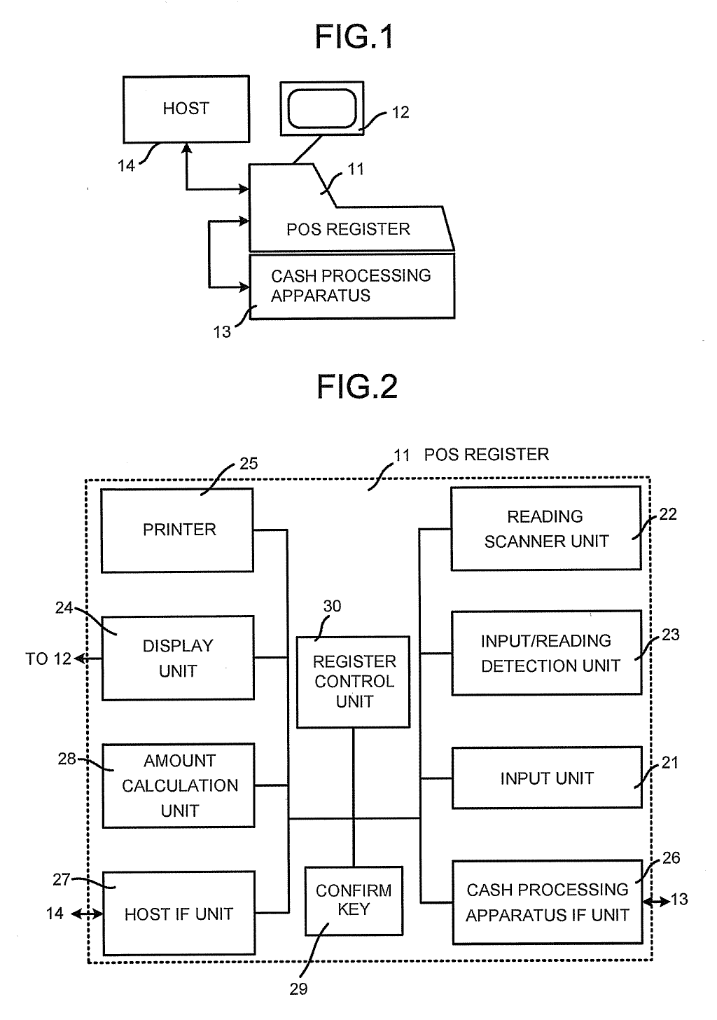

FIG. 1 shows the whole structure of a system according to the first embodiment.

The system comprises: a POS (Point of Sales) register 11 arranged to input/output the price of a commodity and the amount of cash; a display 12 connected with the POS register 11 to display the amount of the input commodities; a cash processing apparatus 13 connected with and placed nearby the POS register 11 to receive an advance and dispense change to a customer; a host 14 connected with the POS register 11 to calculate a change amount according to the quantity, the prices, and total amount of commodities or the amount actually input by the cash processing apparatus 13 and store the purchase information. The POS register 11 and the cash processing apparatus 13 connected therewith make up a register system. The POS register 11 is a cash register having the terminal function of a POS system.

In the first embodiment, the category of a commodity and the amount of the money received from a customer are input from the POS register 11, then an amount difference is calculated, and a change dispensing indication signal is sent from the cash processing apparatus 13 to dispense change. In this way, the cash processing apparatus 13 dispenses change and input the amount of the money received from the customer.

The POS register 11 is a machine which is structured as shown in FIG. 2 and operated by a shop assistant (operator) to input the category of a commodity when a customer requires a checkout and carries out a processing related to a the price of the commodity and the paid cash.

The POS register 11 comprises: an input unit 21 arranged to realize a manual input of a commodity category and a commodity quantity; a reading scanner 22 arranged to read, for example, the barcode of the commodity received from a customer; an input/reading detection unit 23 arranged to detect an input from the input unit 21 or the actions of the reading scanner 22; a display 24 arranged to display the price of each commodity purchased, the total price of the purchased commodities and the difference between the paid amount and a change amount; a printer unit 25 arranged to print the categories and prices of the commodities, the total price of the commodities, the amount received and the change amount on a receipt; a cash processing apparatus interface (IF) unit 26 arranged to receive amount information together with the cash processing apparatus 13; a host interface (IF) unit 27 arranged to receive commodity information and amount information with the host 14; an amount calculation unit 28 arranged to calculate the price of each purchased commodity, the total price of the purchased commodities and the difference between the paid amount and a change amount; a confirmation key 29 for the shop assistant to confirm the total amount of the commodities and the amount received and indicate a transaction ending processing to be carried out; and a register controller unit 30 arranged to control each of the units above.

In the case where a number of commodities of the same category are purchased, the category of the commodities is read by the reading scanner 22, and the number of the commodities is manually input from the input unit 21, thereby saving the reading and scanning time.

The display signal of the display 24 of the POS register 11 is also sent to an external display 12 to display the same content on the display panel of the external display 12.

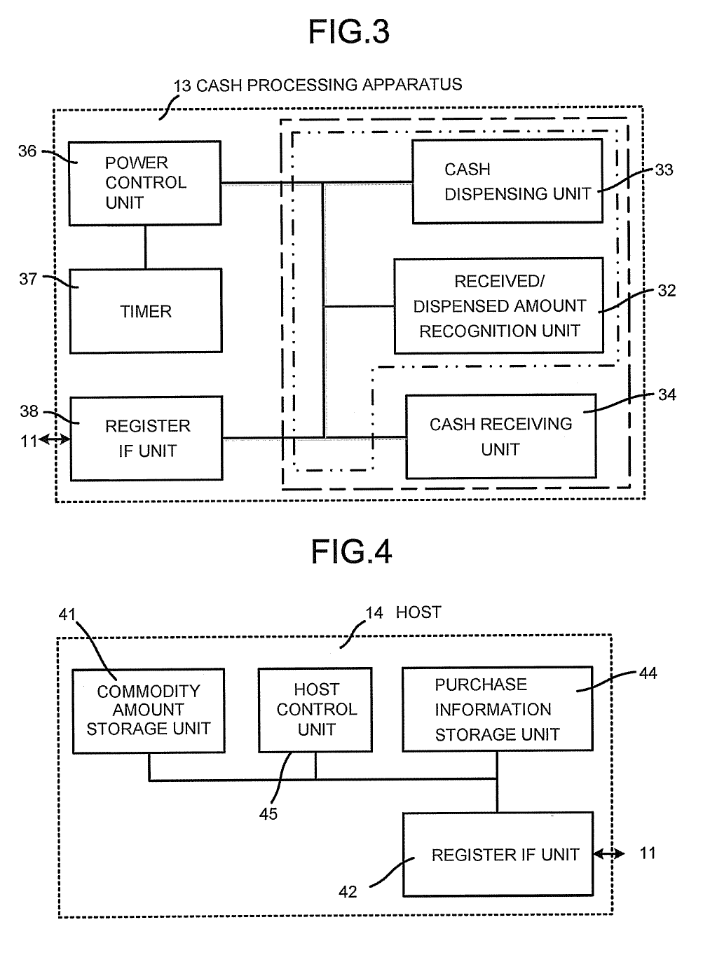

FIG. 3 shows a structural example of the cash processing apparatus 13. The cash processing apparatus 13 comprises: a received/dispensed amount recognition unit 32 arranged to recognize the face values and the amount of the received/dispensed bills/coins; a cash dispensing unit 33 arranged to dispense cash as change; a cash receiving unit 34 arranged to receive cash and detect the received cash; a power control unit 36 arranged to turn off the power supply of each unit under ordinary conditions and carry out a turn-on control in two phases; a timer 37 arranged to detect the time elapsing from the moment each of the units above enters into an idle state; and a register IF unit 38 arranged to receive amount information with the POS register 11.

The power control unit 36 turns off, under ordinary conditions, the power supplies of the amount recognition unit 32, the cash dispensing unit 33 and the cash receiving unit 34. Moreover, when a cash dispensing indication signal is sent from the POS register 11 to the register IF unit 38, the power supplies of the amount recognition unit 32 and the cash dispensing unit 33 are turned on, after a given period of time T 1 elapses, the power supply of the cash receiving unit 34 is turned on. Further, all power supplies are turned on after a second period of time T 2 elapses from the moment the cash receiving unit 34 is turned on so that all units enter into a working state.

When each unit of the cash processing apparatus 13 stops working and no information is sent from the POS register 11, the timer 37 starts a time measurement. Moreover, after the second period of time T2 elapses, the power supply unit 36 is informed of the elapsed time T2 and then turns off the power supplies of the amount recognition unit 32, the cash dispensing unit 33 and the cash receiving unit 34. In measuring time, the power supply unit 36 turns on the power supplies of the amount recognition unit 32, the cash dispensing unit 33 and the cash receiving unit 34 again when information is sent to the register IF unit from the POS register 11. The cash processing apparatus 13 is one kind of cash processing apparatus which is equipped with a cash receiving unit 34 for receiving the cash prepaid by a customer and a cash dispensing unit 33 for disbursing cash to the customer as change. The cash receiving unit 34 and the cash dispensing unit 33 have bill and coin receiving/dispensing functions, respectively.

The shop assistant standing in front of the POS register 11 scans, using the reading scanner 22 of the POS register 11, a commodity printed with a barcode, that is, the barcode of a commodity, to recognize the category of the commodity. Whether or not the category of the commodity is read or whether or not an input is completed by the input unit 21 is detected by the input/reading detection unit 23, the detection information is sent to the power control unit 36 of the cash processing apparatus 13 via the cash processing apparatus IF unit 26 of the POS register 11, then the power control unit 36 turns on the power supplies of the amount recognition unit 32 and the cash dispensing unit 33.

FIG. 4 shows a structural example of the host 14. The host 14 comprises: a commodity amount storage unit 41 arranged to store, according to the category of a commodity category, the category of the commodity corresponding to the amount of the commodity; a register IF unit 42 arranged to receive information with the POS register 11; a purchase information storage unit 44 arranged to store the total amount of commodities or the categories of the commodities purchased by a customer and the amount paid by the customer that is/are sent from the POS register 11; and a host control unit 45 arrange to control each of the units above.

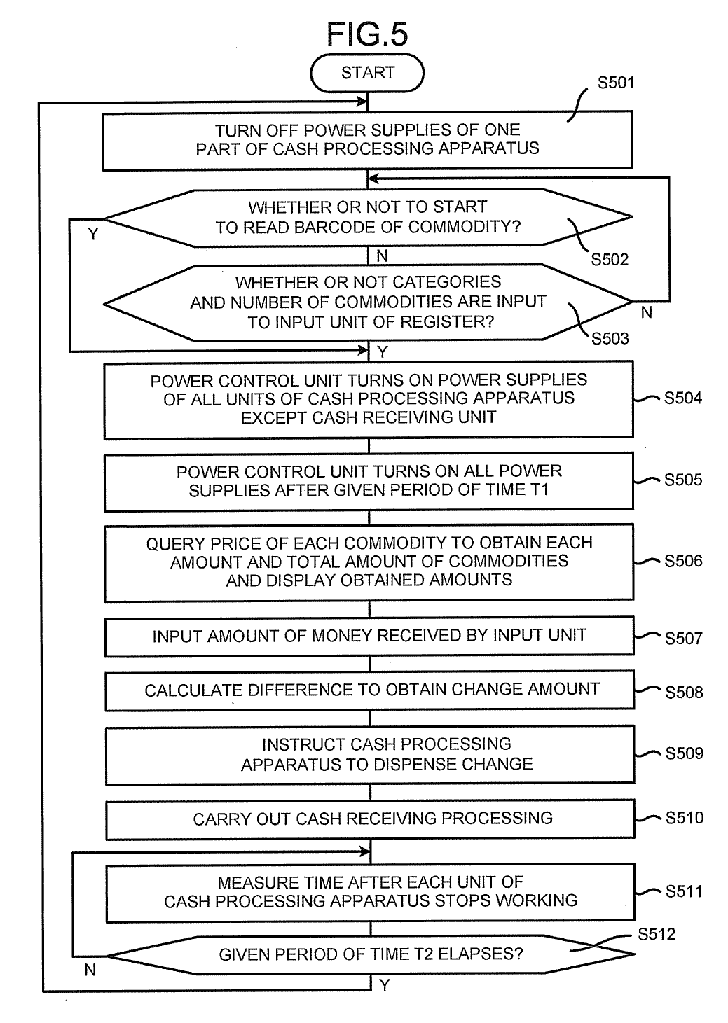

The actions carried out in this embodiment are described with reference to the flow chart shown in FIG. 5. If the cash processing apparatus 13 is started, the power supplies of one part of the units of the cash processing apparatus 13 are turned off in Act S501. That is, the power control unit 36 of the cash processing apparatus 13 turns off the power supplies of the amount recognition unit 32, the cash dispensing unit 33 and the cash receiving unit 34.

In Act S502, whether or not the reading of the barcode of a commodity is started is detected by the reading scanner 22. If the reading of a barcode is not detected, whether or not a commodity category is input to the input 21 of the POS register 11 is detected in Act S503. The detection on the reading of a barcode and the detection on an input to the input unit 21 are completed in the input/reading detection unit 23. When either of the detections is carried out, a detection signal indicative of the detection is sent to the cash processing apparatus 13 via the cash processing apparatus IF unit 26. If the name of a commodity is not recognized by the barcode printed on the commodity, the shop assistant can directly input the category and the number of the commodities manually. If the name of more than 2 commodities of the same category is recognized, the number of the commodities is input manually.

The detection signal is sent to the power supply unit 36 via the register IF unit 38 of the cash processing apparatus 13. If the detection signal is received, the power control unit 36 turns on the power supplies of the amount recognition unit 32 and the cash dispensing unit 33 in Act S504 so that the cash dispensing unit 33 of the cash processing apparatus 13 dispenses change first.

After the power supplies are turned on, in Act S505, the power control unit 36 turns on the power supply of the cash receiving unit 34 after the first given period of time T1 so that all units of the cash processing apparatus 13 enter into a working state.

In Act S502, the shop assistant presses down the confirmation key 29 to uniformly send the commodity categories read as barcodes or input by the input unit 21 to the host 14 via the host IF unit 27. After the commodity categories are received by the register IF unit 42 of the host 14 and stored in the commodity amount storage unit 41 shown in FIG. 4 corresponding to the names of the commodities, the names of the commodities are sent to the POS register 11 via the register IF unit 42 corresponding to the amounts and the total amount of the commodities. Moreover, in Act S506, the amounts and the total amount of the commodities are display on the display 24 and synchronously displayed on the display panel of the display 12 facing the customer.

The amount of the money received from the customer is input from the input unit 21 of the POS register 11 in the following Act S507. In the following Act 5508, the amount calculation unit 28 of the POS register 11 subtracts the total amount of all the commodities from the amount input by the input unit 21 to obtain a change amount.

In Act S509, the POS register 11 instructs, via the cash processing apparatus IF unit 26, the cash processing apparatus 13 to dispense change according to the change amount, and the cash dispensing unit 33 of the cash processing apparatus 13 dispenses the change (paper money and coins). In the following Act S510, the money (paper money and coins) received from the customer is placed in the input unit 21 to carry out a cash receiving processing. The amount of the cash dispensed in Act S509 or received in Act S510 is recognized by the received/dispensed amount recognition unit 32.

The categories, the amounts and the total amount of the commodities as well as the amount received and the change amount are all sent to the host 14 and stored in the purchase information storage unit 44.

In Act S511, the timer 37 starts a time measurement after the cash processing apparatus 13 and each unit of the POS register 11 stop working. In Act S512, after a given period of time T2 elapses from the start of the time measurement, the flow returns to Act S501 so that the power control unit 36 of the cash processing apparatus 13 turns off the power supplies of the amount recognition unit 32, the cash dispensing unit 33 and the cash receiving unit 34 again.

As the amount of the money received from a customer is input by the operator in this embodiment, an error input is prevented.

### The Second Embodiment

In the first embodiment above, the difference between the total amount of commodities and the amount received is calculated in the amount calculation unit 28 of the POS register 11, a cash dispensing indication signal is sent from the POS register 11 to the cash processing apparatus 13, and change is dispensed from the cash dispensing unit 33. However, the amount of the cash received may also be recognized in the cash processing apparatus to obtain the amount of commodities sent from the POS register 11, calculate the difference between the two amounts, and dispense cash.

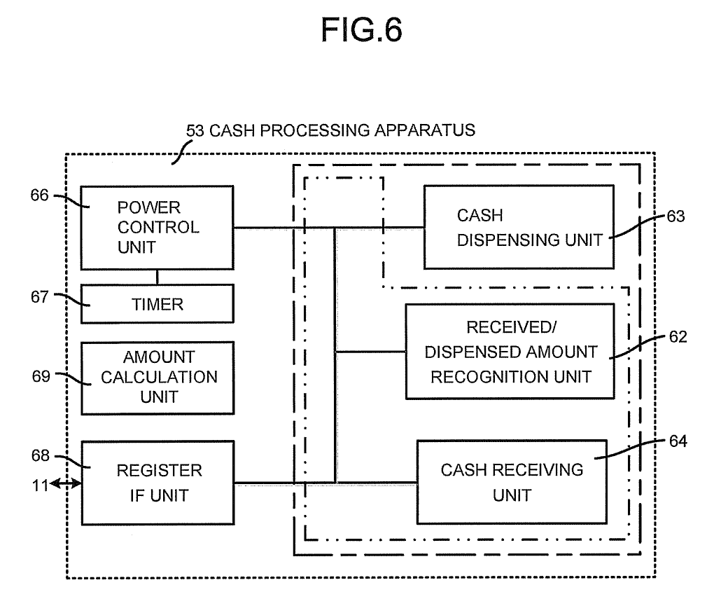

The second embodiment is described below. FIG. 6 shows a structural example of a cash processing apparatus according to this embodiment. The cash processing apparatus 53 shown in FIG. 6 comprises: a received/dispensed amount recognition unit 62 arranged to recognize the face values and the amount of the received/dispensed bills/coins; a cash dispensing unit 63 arranged to dispense cash as change; a cash receiving unit 64 arranged to receive cash and detect the received cash; a power control unit 36 arranged to turn off the power supply of each unit under ordinary conditions and carry out a turn-on control in two phases; a timer 67 arranged to detect the time elapsing from the moment each of the units above enters into an idle state; a register IF unit 68 arranged to receive amount information with the POS register 11; and an amount calculation unit 69 arranged to calculate a change amount.

The cash processing apparatus 53 is different from the cash processing apparatus 13 in having an amount calculation unit 69. In this embodiment, the POS register 11 and the host 14 are structurally identical to those shown in FIG. 2 and FIG. 4. In the cash processing apparatus 53, the calculation of a change amount is carried out by the amount calculation unit 69 but not by the amount calculation unit 28 of the POS register 11.

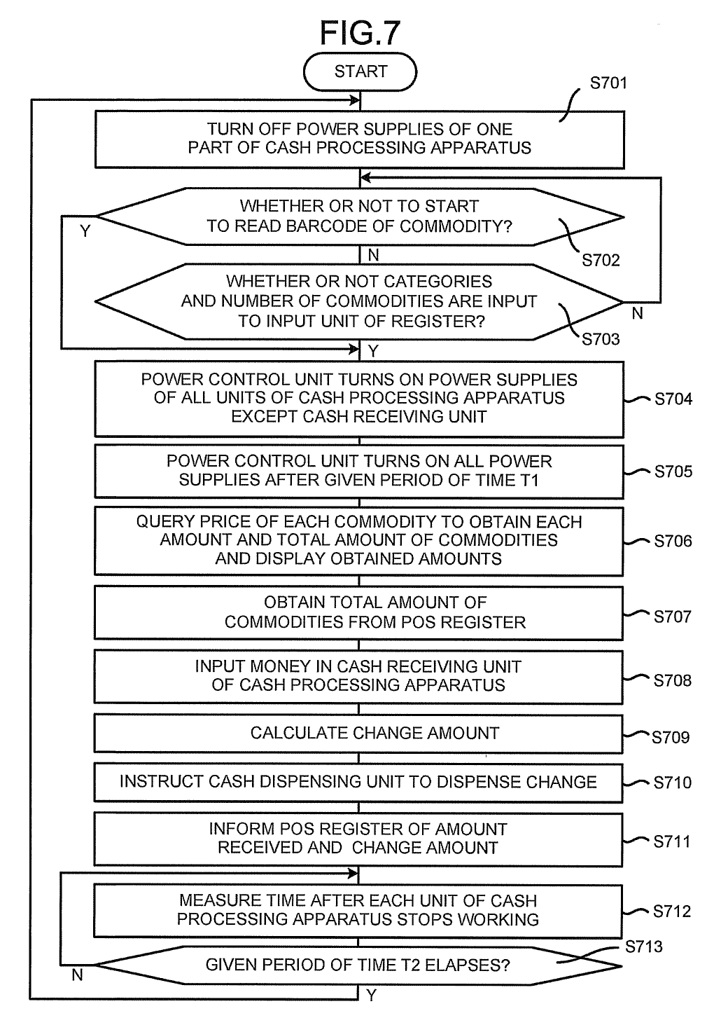

The actions carried out in this embodiment are described with reference to the flow chart shown in FIG. 7.

Acts S701-S703 shown in FIG. 7 are identical to Acts S501-503 shown in FIG. 5. In Act S704, the power control unit 66 turns on power supplies of all the units of the cash processing apparatus 53 except the cash dispensing unit 63, that is, the power control unit 66 turns on power supplies of the received/dispensed amount recognition unit 62 and the cash receiving unit 64.

In Act S705, the power supply unit 66 turns on power supplies of all the units of the cash processing apparatus 53, including the cash dispensing unit 63, after a given period of time T1.

In Act S706, the categories, the unit prices, the number and the total amount of the commodities are displayed on the display unit 24 and the display 12, and in Act S707 shown in FIG. 7, the total amount of the commodities is sent to the amount calculation unit 69 via the register IF unit 68.

In the following Act S708, the money (paper money and coins) received from the customer is placed in the cash receiving unit 64 of the cash processing apparatus 53. The amount input from the cash receiving unit 64 is recognized by the received/dispensed amount recognition unit 62 and then sent to the amount calculation unit 69.

In Act S709, the amount calculation unit 69 calculates a change amount by subtracting the amount sent from the POS register 11 from the amount of the money received from the customer. In Act 5710, the cash dispensing unit 63 is instructed to dispense the amount.

In the following Act S711, the POS register is informed of the amount received and the change amount and sends the amounts together with the categories, the unit prices, the number and the total amount of the commodities to the host 14. The purchase data is stored in the purchase information storage unit 44 of the host 14. In Act S712, a time measurement is started after each unit of the cash processing apparatus 53 stops working, and in Act S713, the flow returns to Act S701 after a given period of time T2.

In this embodiment, a two-phase control can be carried out in the power control unit 66.

In accordance with the second embodiment, the amount of the money received from the customer is automatically recognized by the cash processing apparatus, thus, the cash processing apparatus is advantaged in causing no workload to the operator.

Besides, the category of a commodity is recognized by a barcode in this embodiment. However, the category of a commodity may also be recognized using other codes such as two-dimensional code or directly literally recognized by, for example, a commodity name.

In this embodiment, the category of each commodity is sent to the host 14 from the POS register 11 to query the name and the price of the commodity. In this manner, an appropriate commodity amount can be used even the amount of each commodity stored in the commodity amount storage unit 41 of the host 14 is temporarily changed.

However, a delay in time occurs when the POS register 11 is connected with the host 14 through a network, in this case, before a commodity amount storage unit is arranged in each POS register and activated, for example when a change in date is made, the relation between a commodity and an amount can be pre-downloaded to the commodity amount storage unit. In this way, there is no need to query the price of each commodity in the host 14 using each POS register 11, thus shortening the time needed for displaying the amounts and the total amount of the commodities.

In this embodiment, the host 14 is connected with the POS register 11, and the cash processing apparatus 13 is connected with the POS register 11. However, the cash processing apparatus 13 may be directly connected with the host 14 to directly dispense change according to the change amount calculated by the host 14.

In this embodiment, a host is arranged to carry out a difference calculation. However, the arrangement of the host is not necessary, the total amount and the difference may also be calculated by the POS register. Further, purchase information may be stored in the register.

In embodiments 1 and 2 above, the power control unit turns on/off the power supplies of the received/dispensed amount recognition unit, the cash dispensing unit and the cash receiving unit. However, the power supply of the cash processing apparatus may be controlled by detecting a signal from the POS register.

In the embodiments above, advance is received and change is dispensed from the same opening which serves as the only money tray 31, however, the openings for receiving advance and disbursing change may also be different trays 31. In addition, paper money and coins may be respectively received and dispensed from different openings.

According to the embodiments above, a power-saving cash processing apparatus is provided.

In the embodiments above, the power supplies of the units of the cash processing apparatus 13 are turned on/off synchronously, however, the power supplies may be turned on/off in an out of synchronization manner. For instance, a money receiving sensor is arranged at a money receiving opening to detect the received money, if the power supply of each unit of the cash processing apparatus is turned on based on the detection of the money receiving sensor, then the power supply of the money receiving sensor is turned on prior to those of the other units, thus, the power supplies of the other units are turned off for a longer time to save power.

In the embodiments above, the input unit of the cash register is exemplarily described as a unit for inputting the category of a commodity. However, the input unit may also be a unit for inputting the data related to the receiving of sales-irrelevant cash.

The input unit arranged to receive sales-irrelevant cash has, for example, an exchange key, a cash receiving key and a cash dispensing key. The exchange key is operated when the face value of the money to be exchanged is smaller than that of the money received, for instance, when it is desired to exchange a 10000-yen bill to one 5000-yen bill and five 1000-yen bills in Japan. The cash dispensing key is operated to dispense cash as change. The cash receiving key is operated to recycle cash.

In the embodiments above, the cash processing apparatus 13 is exemplarily described which receives cash from a customer in advance and then dispenses change to the customer, however, the cash processing apparatus may be either of a cash receiving unit for receiving cash from a customer and a cash dispensing unit for disbursing cash for the customer as change. In addition, a change machine may also be arranged in the cash processing apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cash register, that includes an input unit and is connected with a cash processing apparatus having a power control unit for turning on or off the power supply of each unit, comprising:
a power-on unit which turns on the power supply of the cash processing apparatus using the power control unit after the category of a commodity is input through the input unit.

2. The cash register according to claim 1, wherein
the input unit inputs the category of a commodity.

3. The cash register according to claim 1, wherein
the input unit inputs the data related to the receiving of a cash category.

4. A cash processing apparatus, comprising:
a cash receiving unit configured to receive cash and detect the received cash; and
a power control unit configured to at least turn off the power supply of the cash receiving unit, wherein
the cash processing apparatus is connected with a cash register which is configured to input the category and the amount of a category and in which the power supply of the cash receiving unit is turned on by the power control unit when the category or amount of the commodity is input through the cash register.

5. A cash processing apparatus, comprising:
a cash dispensing unit configured to dispense cash; and
a power control unit configured to turn off the power supply of the cash dispensing unit, wherein
the cash processing apparatus is connected with a cash register which is configured to carry out a processing related to a commodity category and a dispensing amount and in which the power supply of the cash dispensing unit is turned on by the power control unit when the commodity category is input through the cash register.
